(19) United States
(12) Patent Application Publication
(10) Pub. No.: US 2026/0018353 A1
(43) Pub. Date: Jan. 15, 2026

(54) LIGHT-EMITTING KEYBOARD

(71) Applicant: KUNSHAN JOING TECHNOLOGY CO., LTD., Suzhou, Jiangsu (CN)

(72) Inventors: Xiuqin DING, Suzhou, Jiangsu (CN); Junsheng LU, Suzhou, Jiangsu (CN); Changyou BIAN, Suzhou, Jiangsu (CN); Dejun MEI, Suzhou, Jiangsu (CN); Sanming HUANG, Suzhou, Jiangsu (CN); Xiejun ZHANG, Suzhou, Jiangsu (CN); Song GU, Suzhou, Jiangsu (CN)

(21) Appl. No.: 18/996,345

(22) PCT Filed: Jul. 29, 2022
(86) PCT No.: PCT/CN2022/109058

§ 371 Date: Jan. 17, 2025

(51) Int. Cl. H01H 13/83; H01H 13/7065; H01H 13/79

(52) U.S. Cl. CPC H01H 13/83; H01H 13/7065; H01H 13/79

(57) ABSTRACT

A light-emitting keyboard is disclosed, which includes a membrane switch, a key cap located above the membrane switch, scissors arranged below the key cap and a light-emitting assembly. The light-emitting assembly includes a bottom plate, an insulation layer arranged on the bottom plate, a circuit layer located on the insulation layer and having circuits, a protective layer covering the circuits and exposing end portions of the circuits, a light-emitting bead arranged on at least two spaced end portions and electrically connected to the end portions, and a layered component arranged on outer side of the light-emitting bead. A buckle extending upward and penetrating the membrane switch is connected to lower edges of the scissors such that a position of the light-emitting bead corresponds to that of the key cap, and the light-emitting bead emits light to illuminate the key cap when the circuit layer is energized.

### CROSS-REFERENCE TO RELATED APPLICATIONS

This application is a national stage of PCT Application No. Number PCT/CN2022/109058, having a filing date of Jul. 29, 2022, the entire content of which is hereby incorporated by reference.

### TECHNICAL FIELD

The present disclosure belongs to the field of electronic switch, and specifically relates to a light-emitting keyboard.

### BACKGROUND

Keyboards are the most commonly used and primary input device, through which English letters, Chinese characters, numbers, punctuation marks, etc. can be input into a computer, thereby giving commands or inputting information to the computer. Traditional keyboards do not have a light-emitting function, and when used in dark environments, marks on key caps are difficult to recognize, making input difficult. Keyboards with light-emitting functions have been provided in the market to solve this problem.

For example, Chinese patent CN104701055B disclosed this type of light-emitting keyboard, this solution adopts a configuration of a light guide plate under the bottom plate and a light-emitting unit on one side of the light guide plate, wherein the light guide plate is used to transmit the light emitted by the light-emitting unit to illuminate the key cap. Due to multiple reflections and refractions of light inside the light guide plate, the light-emitting effect is poor, the energy utilization rate is low, and it is difficult to display multiple colors simultaneously, but it is superior in that the material is cheap and easy to obtain, and the processing cost is low, thus it is the mainstream design of light-emitting keyboards. For another example, the light-emitting keyboard disclosed in Chinese patent CN202282283U adopts a solution including an LED module under the bottom plate, wherein an LED component of the LED module emits light directly upwards to illuminate the key cap. However, additional holes on the bottom plate for light transmission are needed, which will reduce the strength of the bottom plate and make the stamping mold more complex and costly, and which also requires an additional LED substrate (which usually is a flexible FPC material) to fix and package the LED component, resulting in high cost of material and processing, low packaging efficiency and yield. At the same time, both types of light-emitting keyboards require additional boards placed under the bottom plate, which will increase the overall thickness and weight of the keyboards and result in poor heat dissipation.

### SUMMARY

An object of the present disclosure is providing a keyboard with light-emitting function, good lighting effect, low cost, lightweight, and good heat dissipation effect, to overcome drawbacks of conventional art.

An aspect of the present disclosure provides a light-emitting keyboard, which includes:
a membrane switch, comprising several pressing chambers;
a key cap located above the membrane switch and corresponding to the pressing chambers;
scissors arranged below the key cap, upper edges of the scissors being connected to the key cap;
a light-emitting assembly;

the light-emitting assembly comprises a bottom plate, an insulation layer arranged on the bottom plate, a circuit layer located on the insulation layer and having a plurality of circuits, a protective layer covering the circuits and exposing end portions of the circuits, a light-emitting bead arranged on at least two spaced end portions and electrically connected to the end portions, and a layered component arranged on outer side of the light-emitting bead for protection and lens effect,
wherein the bottom plate, the insulation layer, the circuit layer and the protective layer constitute a light-emitting assembly circuit board located below the membrane switch and supporting the membrane switch, a buckle extending upward and penetrating the membrane switch is formed on the light-emitting assembly circuit board, the buckle is connected to lower edges of the scissors such that a position of the light-emitting bead corresponds to that of the key cap, and the light-emitting bead is configured to emit light to illuminate the key caps when the circuit layer is energized.

In an embodiment, the bottom plate is a metal plate.

In an embodiment, the metal plate is an aluminum plate or a stainless-steel plate.

In an embodiment, the insulation layer is a cured insulation material coated on the bottom plate.

In an embodiment, the insulation material comprises a resin.

In an embodiment, the circuit layer is an etched metal layer covering the insulation layer; or, the circuit layer is a cured conductive paste printed on the insulation layer; or, the circuit layer comprises a lower layer being an etched metal layer covering the insulation layer and an upper layer being a cured conductive paste printed on the lower layer.

In an embodiment, the protective layer is a cured insulation ink or insulation paint coated on the circuits; or, the protective layer is an insulation film covering the circuits.

In an embodiment, the light-emitting bead comprises a LED bead.

In an embodiment, the layered component is a cured adhesive covering the outer side of the light-emitting bead; or, the layered component is a protective sheet adhered to the light-emitting bead.

In an embodiment, a single key cap corresponds to one light-emitting bead, which is located on one side of the key cap where the pressing chamber is located on; or, a single key cap corresponds to a plurality of light-emitting beads, the plurality of light-emitting beads are distributed around one of the pressing chambers corresponding to the key cap.

In an embodiment, an accommodating hole for avoiding the light-emitting bead and the layered component is arranged on the membrane switch.

In an embodiment, the accommodating hole is a through-hole or a blind hole, and a height of the accommodating hole is greater than or equal to a height of the light-emitting bead protruding from the light-emitting assembly circuit board.

In an embodiment, a method for manufacturing the light-emitting assembly comprises the following steps:
A—coating an insulation material on the bottom plate to form the insulation layer;
B—covering a metal layer on the insulation layer and etching a part of the metal layer to form a circuit layer with a plurality of circuits, or, printing a conductive paste on the insulation layer and curing to form a circuit layer with a plurality of circuits;
C—coating an insulation ink on the circuits, curing to form the protective layer, and exposing end portions of the circuits during coating to form connecting ends;
D—stamping the bottom plate upwards to fold at least the bottom plate and the insulation layer upwards, to form the buckle;
E—spot coating or printing a conductive adhesive on the connecting ends;
F—mounting the light-emitting bead on at least two spaced connecting ends by using a placement device;
G—electrically connecting the light-emitting bead and the connecting ends;
H—coating an adhesive or bonding a protective sheet on the light-emitting bead to form the layered component, obtaining the light-emitting assembly.

Due to the use of the above technical solutions, the present disclosure has the following advantages over conventional art:
the light-emitting keyboard provided in the present disclosure comprises a membrane switch having pressing chambers, a key cap located above the membrane switch and corresponding to the pressing chambers, scissors arranged below the key caps with their upper edges being connected to the key cap, and a light-emitting assembly, wherein the light-emitting assembly includes a bottom plate, an insulation layer arranged on the bottom plate, a circuit layer located on the insulation layer and having a plurality of circuits, a protective layer covering the circuits and exposing end portions of the circuits, a light-emitting bead mounted on at least two spaced end portions and electrically connected to the end portions, and a layered component arranged on outer side of the light-emitting bead for protection and lens effects, and the bottom plate, the insulation layer, the circuit layer and the protective layer constitute a light-emitting assembly circuit board located below the membrane switch and supporting the membrane switch, a buckle extending upward and penetrating the membrane switch on the light-emitting assembly circuit board is formed, the buckle is connected to lower edges of the scissors, and the position of the light-emitting beads correspond to that of the key cap, when the circuit layer is energized, the light-emitting bead emits light to illuminate the key cap, such that the light-emitting function is achieved, and the lighting effect is good. The good lighting effect is mainly observed in the following aspects: the light emitted by the light-emitting bead does not need to be transmitted through a light guide plate, and it can directly illuminate the key cap, the layered component that acts as a lens can soften the light, making the light illuminating the key cap be not dazzling; there is no need to provide holes on the bottom plate for light transmission, the strength of the bottom plate is not affected, in addition, the circuit layer, the insulation layer, the protective layer, the light-emitting bead and the layered component can be conveniently arranged by utilizing the characteristics of high strength of the bottom plate, such that the cost is low, the light and thin effect is achieved, and the heat dissipation effect is good. The low cost is mainly observed in the following aspects: 1—there is no need to use expensive FPC boards, with low material cost; 2—there is no need to provide additional transparent holes on the bottom plate for light transmission, the mold structure is simpler and the cost is lower; 3—it can be better integrated into the existing production system, with low production cost; 4—the packaging efficiency and yield of the light-emitting bead are high, and the cost is low. The lightness and thinness are mainly observed in: the number of layers of the light-emitting assembly board is small, the thickness of a single layer of board is relatively thin, the total weight is light, and the total thickness is thin.

### BRIEF DESCRIPTION

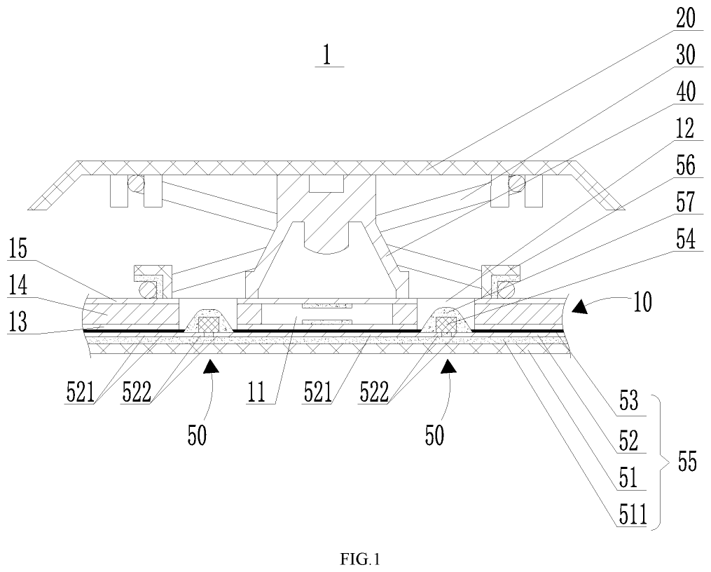

FIG. 1 is an enlarged schematic sectional view showing a single key cap according to Embodiment 1 of the present disclosure;

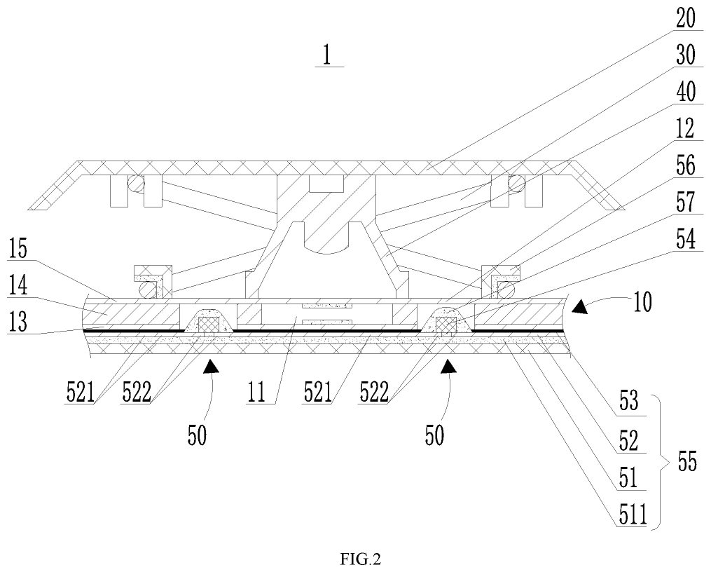

FIG. 2 is an enlarged schematic sectional view showing a single key cap according to Embodiment 2 of the present disclosure;

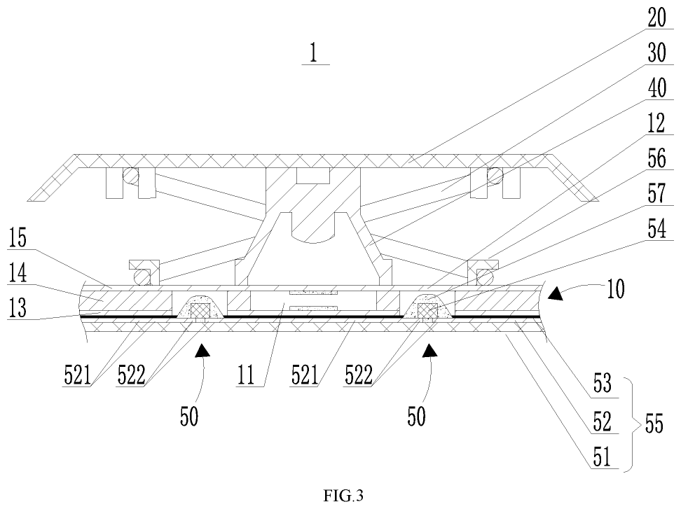

FIG. 3 is an enlarged schematic sectional view showing a single key cap according to Embodiment 3 of the present disclosure;

wherein: 1—light-emitting keyboard; 10—membrane switch; 11—pressing chamber; 12—accommodating hole; 13—lower membrane; 14—partition board; 15—upper membrane; 20—key cap; 30—scissor; 40—elastic button; 50—light-emitting assembly; 51—bottom plate; 511—insulation layer; 52—circuit layer; 521—circuit; 522—end portion; 53—protective layer; 54—light-emitting bead; 55—light-emitting assembly circuit board; 56—buckle; 57—layered component.

### DETAILED DESCRIPTION

The preferred embodiments of the present disclosure are explained below in detail combining with the accompanying drawings so that the advantages and features of the present disclosure can be easily understood by the skilled persons in the art, and thus it is clear to define the protective scope of the present disclosure.

The up-down direction described in the present disclosure refers to the up-down direction in FIG. 1.

### Embodiment 1

As shown in FIG. 1, a light-emitting keyboard 1 provided in the present disclosure includes: a membrane switch 10, key caps 20, scissors 30, elastic buttons 40, and a light-emitting assembly 50, wherein, the membrane switch 10 has several spaced pressing chambers 11; the key caps 20 are located above the membrane switch 10 and correspond one-to-one to the pressing chambers 11; the scissors 30 are arranged below the key caps 20, and upper edges of the scissors 30 are connected to clamping columns on lower surfaces of the key caps 20; the elastic buttons 40 pass through cavities formed in middle portions of the scissors 30, upper and lower end faces of the elastic buttons 40 are respectively pressed against the key caps 20 and the membrane switch 10, and the elastic buttons 40 provides elastic force for resetting the key caps 20; the light-emitting assembly 50 comprises a bottom plate 51, an insulation layer 511 arranged on the bottom plate 51, a circuit layer 52 located on the insulation layer 511 and having a plurality of circuits 521, a protective layer 53 covering the circuits 521 and exposing end portions 522 of the circuits, a light-emitting bead 54 mounted on two spaced end portions 522 and electrically connected to the end portions 522, and a layered component 57 arranged on outer side of the light-emitting beads 54 for protection and lens effects (scattering light), the bottom plate 51, the insulation layer 511, the circuit layer 52 and the protective layer 53 constitute a light-emitting assembly circuit board 55 located below the membrane switch 10 and supporting the membrane switch 10. A buckle 56 extending upward and penetrating the membrane switch 10 is formed on the light-emitting assembly circuit board 55, and an upper end portion of the buckle 56 is connected to lower edges of the scissors 30, such that the scissors 30 can be pressed and raised, and the position of the light-emitting beads 54 corresponds to that of the key caps 20, this correspondence means that at least one light-emitting bead 54 is located below each key cap 20, when the circuit layer 52 is energized, the light-emitting beads 54 emit light to illuminate the key caps 20.

The advantages of this arrangement are that it can make the light-emitting keyboard have the light-emitting function and good lighting effect; the good lighting effect is mainly observed in that the light emitted by the light-emitting beads does not need to be transmitted through a light guide plate, and can directly illuminate the key caps, the layered component that acts as a lens can soften the light, making the light illuminating the key caps be not dazzling; there is no need to provide holes on the bottom plate for light transmission, the strength of the bottom plate is not affected, in addition, it can utilize the high strength of the bottom plate as a substrate for the light-emitting assembly circuit board to support the membrane switch, the light-emitting bead, and the layered component, facilitating the arrangement of the circuit layer, the protective layer, the light-emitting bead and the layered component, such that the cost is low, the light and thin effect is achieved, and the heat dissipation effect is good. The low cost is mainly observed in the following aspects: 1—there is no need to use expensive FPC boards, with low material cost; 2—there is no need to provide additional transparent holes on the bottom plate for light transmission, the mold structure is simpler and the cost is lower; 3—it can be better integrated into the existing production system, with low production cost; 4—the packaging efficiency and yield of light-emitting bead are high, and the cost is low. The lightness and thinness are mainly observed in that the number of layers of the light-emitting assembly board is small, the thickness of a single layer of board is relatively thin, the total weight is light, and the total thickness is thin.

The bottom plate 51 is a metal plate, preferably aluminum plate or stainless-steel plate, to reduce the thickness of the bottom plate 51 as much as possible under the same strength conditions.

In this embodiment, the insulation layer 511 is formed by curing a resin coated on the bottom plate 51, and the protective layer 53 is formed by curing an insulation ink coated on the circuits 521, to reduce the thickness of the insulation layer 511 and the protective layer 53 as much as possible under the same insulation effect and protection effect, and it is also convenient to change the thickness of the insulation layer 511 and the protective layer 53 to meet different needs, in other embodiments, the protective layer 53 is formed by curing an insulation paint coated on the circuits 521, or the protective layer 53 is an insulation film covering the circuits 521.

In this embodiment, the circuit layer 52 is formed by etching a metal layer covering the insulation layer 511. In other embodiments, the circuit layer 52 is formed by curing a conductive paste printed on the insulation layer 511, or, the circuit layer 52 comprises a lower layer formed by etching a metal layer covering the insulation layer 511 and an upper layer formed by curing a conductive paste printed on the lower layer.

In this embodiment, the light-emitting bead is a LED bead, and the layered component 57 is formed by curing an adhesive wrapped around the outer side of the light-emitting bead 54. In other embodiments, the layered component 57 is a protective sheet adhered to the light-emitting bead 54, and the material of the protective sheet may be ceramics, silicone, epoxy resin, acrylic, etc.

In this embodiment, two light-emitting beads 54 correspond to one key cap 20, and the two light-emitting beads 54 corresponding to the same key cap 20 are symmetrically distributed on two sides of the pressing chamber 11 corresponding to this key cap 2. In other embodiments, one light-emitting bead 54 corresponds to one key cap 20, and the single light-emitting bead 54 is located on one side of the pressing chamber 11 corresponding to this key cap 20; or, three or more light-emitting beads 54 correspond to one key cap 20, and these light-emitting beads 54 are distributed around the pressing chamber 11 corresponding to this key cap 20.

In this embodiment, the membrane switch 10 is provided with accommodating holes 12 for avoiding the light-emitting bead 54 and the layered component 57, the accommodating holes 12 are through-holes, and when the membrane switch 10 is supported on the light-emitting assembly 50, the lower surface of the membrane switch 10 can make surface contact with the upper surface of the light-emitting assembly circuit board 55 to enhance stability.

In this embodiment, a method for manufacturing the light-emitting assembly 50 comprises the followings steps:
A—coating a resin on the bottom plate 51, and curing it, to form the insulation layer 511;
B—covering a copper layer on the insulation layer 511 and etching a portion of the copper layer to form a circuit layer 52 with a plurality of spaced circuits 521, or, printing a conductive paste on the insulation layer 511 and curing it to form a circuit layer 52 with a plurality of spaced circuits 521, where the conductive paste is a conductive silver paste or a conductive carbon paste;
C—coating an insulation ink on the circuits 521, curing it to form the protective layer 53, and exposing end portions 522 of the circuits 521 during coating to form connecting ends;
D—stamping the bottom plate 51 from bottom to top, causing at least the bottom plate 51 and the insulation layer 511 to fold upwards, forming the buckle 56;
E—spot coating or printing a conductive adhesive on the connecting ends;
F—mounting the light-emitting bead 54 on at least two spaced connecting ends by using a placement device;
G—soldering the light-emitting beads 54 and the connecting ends by using a reflow soldering device, and making them being electrically connected;
H—coating an adhesive or bonding a protective sheet on the light-emitting bead 54 to form the layered component 57, obtaining the light-emitting assembly 50.

This arrangement has the following advantages: it has simple steps, high production efficiency, high yield rate, and low cost.

### Embodiment 2

As shown in FIG. 2, Embodiment 2 is basically the same as Embodiment 1, by differing in that, in Embodiment 2, the accommodating holes 12 are blind holes, and the height of the accommodating holes 12 is greater than the height of the light-emitting beads 54 and the layered component 57 protruding from the light-emitting assembly circuit board 55, specifically, the accommodating holes 12 pass through the lower membrane 13 and the partition plate 14 of the membrane switch 10 from bottom to top, such that the upper membrane 15 of the membrane switch 10 forms a shield above the accommodating holes 12, playing a role in dust prevention, waterproofing, and soft lighting.

### Embodiment 3

As shown in FIG. 3, Embodiment 3 is basically the same as Embodiment 2, by differing in that, in Embodiment 3, the bottom plate 51 and the insulation layer 511 are integrated, and the buckle 56 and the bottom plate 51 are formed as a whole, if the bottom plate 51 is made of an insulation material (resin, etc.), the insulation characteristics of the bottom plate 51 can be used to dispose the circuit layer 52 without the need for an additional insulation layer 511, which can further simplify the production process and reduce cost.

### Embodiment 4

Embodiment 4 is basically the same as Embodiment 1, by differing in that, in Embodiment 4, there are a plurality of circuit layers 52 and a plurality of protective layers 53, which are arranged in sequence in the up-down direction, adjacent circuit layers 52 are separated by a protective layer 53, and another protective layer 53 is arranged on the topmost circuit layer 52, and the advantage of this arrangement is that it can improve the phenomenon of poor electrical performance (such as excessive resistance) caused by a single circuit 521 being too long, preferably, it is suitable to have two to three layers each for the circuit layer 52 and the protective layer 53.

### Embodiment 5

Embodiment 5 is basically the same as Embodiment 2, by differing in that, in Embodiment 5, there are a plurality of circuit layers 52 and a plurality of protective layers 53, which are arranged in sequence in the up-down direction, adjacent circuit layers 52 are separated by one protective layer 53, and one protective layer 53 is arranged on the topmost circuit layer 52, and the advantage of this arrangement is that it can improve the phenomenon of poor electrical performance (such as excessive resistance) caused by a single circuit 521 being too long, preferably, it is suitable to have two to three layers each for the circuit layer 52 and the protective layer 53.

The embodiments described above are only for illustrating the technical concepts and features of the present disclosure, and are intended to make a person familiar with the technology being able to understand the content of the present disclosure and thereby implement it, and should not limit the protective scope of this disclosure. Any equivalent variations or modifications according to the spirit of the present disclosure should be covered by the protective scope of the present disclosure.

1. A light-emitting keyboard, comprising:
a membrane switch, comprising several a pressing chambers;
a key cap located above the membrane switch;
scissors arranged below the key cap, upper edges of the scissors being connected to the key cap; and
a light-emitting assembly;
wherein
the light-emitting assembly comprises a bottom plate, an insulation layer arranged on the bottom plate, a circuit layer located on the insulation layer and having a plurality of circuits, a protective layer covering the circuits and exposing end portions of the circuits, a light-emitting bead arranged on at least two spaced end portions and electrically connected to the end portions, and a layered component arranged on outer side of the light-emitting bead for protection and lens effect, wherein the bottom plate, the insulation layer, the circuit layer and the protective layer constitute a light-emitting assembly circuit board located below the membrane switch and supporting the membrane switch, a buckle extending upward and penetrating the membrane switch is formed on the light-emitting assembly circuit board, the buckle is connected to lower edges of the scissors such that a position of the light-emitting bead corresponds to that of the key cap, and the light-emitting bead is configured to emit light to illuminate the key cap when the circuit layer is energized.

2. The light-emitting keyboard according to claim 1, wherein the bottom plate is a metal plate.

3. The light-emitting keyboard according to claim 2, wherein the metal plate is an aluminum plate or a stainless-steel plate.

4. The light-emitting keyboard according to claim 1, wherein the insulation layer is a cured insulation material coated on the bottom plate.

5. The light-emitting keyboard according to claim 4, wherein the insulation material comprises a resin.

6. The light-emitting keyboard according to claim 1, wherein the circuit layer is an etched metal layer covering the insulation layer; or, the circuit layer is a cured conductive paste printed on the insulation layer; or, the circuit layer comprises a lower layer being an etched metal layer covering the insulation layer and an upper layer being a cured conductive paste printed on the lower layer.

7. The light-emitting keyboard according to claim 1, wherein the protective layer is a cured insulation ink or insulation paint coated on the circuits; or, the protective layer is an insulation film covering the circuits.

8. The light-emitting keyboard according to claim 1, wherein the light-emitting bead comprises a LED bead.

9. The light-emitting keyboard according to claim 1, wherein the layered component is a cured adhesive covering the outer side of the light-emitting bead;
or, the layered component is a protective sheet adhered to the light-emitting bead.

10. The light-emitting keyboard according to claim 1, wherein a single key cap corresponds to one light-emitting bead, which is located on one side of the key cap where the pressing chamber is located on; or, a single key cap corresponds to a plurality of light-emitting beads, the plurality of light-emitting beads are distributed around the pressing chambers corresponding to the key cap.

11. The light-emitting keyboard according to claim 1, wherein an accommodating hole for avoiding the light-emitting bead and the layered component is arranged on the membrane switch;
the accommodating hole is a through-hole or a blind hole, and a height of the accommodating hole is greater than or equal to a height of the light-emitting bead protruding from the light-emitting assembly circuit board.

12-14. (canceled)

15. A light-emitting keyboard, comprising:
a membrane switch comprising a pressing chambers;
a key cap located above the membrane switch;
scissors arranged below the key cap, upper edges of the scissors being connected to the key cap; and
a light-emitting assembly;
wherein the light-emitting assembly comprises a bottom plate made of an insulation material, an insulation layer arranged on the bottom plate, a circuit layer located on the insulation layer and having a plurality of circuits, a protective layer covering the circuits and exposing end portions of the circuits, a light-emitting bead arranged on at least two spaced end portions and electrically connected to the end portions, and a layered component arranged on outer side of the light-emitting bead for protection and lens effects, the bottom plate, the circuit layer and the protective layer constitute a light-emitting assembly circuit board located below the membrane switch and supporting the membrane switch, a buckle extending upward and penetrating the membrane switch is formed on the light-emitting assembly circuit board, the buckle is connected to lower edges of the scissors such that a position of the light-emitting bead corresponds to that of the key cap, and the light-emitting bead is configured to emit light to illuminate the key cap when the circuit layer is energized.

16. The light-emitting keyboard according to claim 15, wherein, the insulation material comprises a resin.

17. The light-emitting keyboard according to claim 15, wherein, the circuit layer is an etched metal layer covering the insulation layer, or, the circuit layer is a cured conductive paste printed on the insulation layer, or, the circuit layer comprises a lower layer formed being an etched metal layer covering the insulation layer and an upper layer being a cured conductive paste printed on the lower layer.

18. The light-emitting keyboard according to claim 15, wherein, the protective layer is a cured insulation ink or insulation paint coated on the circuits; or, the protective layer is an insulation film covering the circuits.

19. The light-emitting keyboard according to claim 15, wherein, the light-emitting bead comprises a LED bead;
the layered component is a cured adhesive covering the outer side of the light-emitting bead, or, the layered component is a protective sheet adhered to the light-emitting bead.

20. (canceled)

21. The light-emitting keyboard according to claim 15, wherein, a single key cap corresponds to one light-emitting bead, which is located on one side of the key cap where the pressing chamber is located on; or, a single key cap corresponds to a plurality of light-emitting beads, which are distributed around the pressing chambers corresponding to the key cap.

22. The light-emitting keyboard according to claim 15, wherein, an accommodating hole for avoiding the light-emitting bead and the layered component is arranged on the membrane switch;
the accommodating hole is a through-holes or a blind hole, and a height of the accommodating hole is greater than or equal to a height of the light-emitting bead protruding from the light-emitting assembly circuit board.

23-25. (canceled)

26. The light-emitting keyboard according to claim 1, wherein,
a plurality of circuit layers and a plurality of protective layers are arranged in sequence in an up-down direction, two adjacent circuit layers of the plurality of circuit layers are separated by one of the plurality of protective layers, and another one of the plurality of protective layers is arranged on a topmost circuit layer of the plurality of circuit layers.

27. A method for manufacturing the light-emitting assembly according to claim 1, comprising:
A—coating an insulation material on the bottom plate to form the insulation layer;
B—covering a metal layer on the insulation layer and etching a part of the metal layer to form a circuit layer with a plurality of circuits, or, printing a conductive paste on the insulation layer and curing to form a circuit layer with a plurality of circuits;
C—coating an insulation ink on the circuits, curing to form the protective layer, and exposing end portions of the circuits during coating to form connecting ends;
D—stamping the bottom plate upwards to fold at least the bottom plate and the insulation layer upwards, to form the buckle;
E—spot coating or printing a conductive adhesive on the connecting ends;
F—mounting the light-emitting bead on at least two spaced connecting ends by using a placement device;
G—electrically connecting the light-emitting bead and the connecting ends; and
H—coating an adhesive or bonding a protective sheet on the light-emitting bead to form the layered component, obtaining the light-emitting assembly.
